(19) United States
(12) Patent Application Publication
(10) Pub. No.: US 2008/0144435 A1
(43) Pub. Date: Jun. 19, 2008

(54) Deep low frequency towed-array marine survey

(76) Inventor: Lawrence C. Morley, The Woodlands, TX (US)

Correspondence Address: WesternGeco L.L.C.;Jeffrey E. Griffin, 10001 Richmond Avenue, HOUSTON, TX, 77042-4299, US

(21) Appl. No.: 11/652,891

(22) Filed: Jan. 12, 2007

Related U.S. Application Data
(60) Provisional application No. 60/870,277, filed on Dec. 15, 2006.

(51) Int. Cl. G01V 1/28

(52) U.S. Cl. 367/21

(57) ABSTRACT

A method includes: acquiring a set of multicomponent seismic data in a towed-array, marine seismic survey at a low seismic frequency and at a deep tow depth; and processing the acquired seismic data to attenuate the affect of reverberations in the water column thereon. A method for processing seismic data includes: accessing a set of multicomponent seismic data acquired in a towed-array, marine seismic survey at a low seismic frequency and at a deep seismic depth; and processing the acquired seismic data to attenuate the affect of reverberations in the water column thereon. A method of acquiring multicomponent seismic data includes: towing a marine seismic array at a deep seismic depth; imparting a seismic survey signal into the marine environment, the seismic survey signal having a low seismic frequency; detecting a reflection of the seismic survey signal with the towed marine seismic array; and recording the detected reflection.

The current non-provisional patent application claims the priority of co-pending provisional patent application, attorney docket number 594-25621-US-PRO, Ser. No. 60/870,277, filed on Dec. 15, 2006, by the same inventor, with the same title.

### BACKGROUND OF THE INVENTION

1. Field of the Invention

The present invention pertains to multi-component towed-array marine seismic surveying, and, more particularly, to the ability of such a survey to capture and faithfully record the low frequency portion of the seismic signal.

2. Description of the Related Art

Seismic exploration involves surveying subterranean geological formations for hydrocarbon deposits. A survey typically involves deploying acoustic source(s) and acoustic sensors at predetermined locations. The sources impart acoustic waves into the geological formations. The acoustic waves are sometime also referred to as “pressure waves” because of the way they propagate. Features of the geological formation reflect the pressure waves to the sensors. The sensors receive the reflected waves, which are detected, conditioned, and processed to generate seismic data. Analysis of the seismic data can then indicate probable locations of the hydrocarbon deposits.

Some surveys are known as “marine” surveys because they are conducted in marine environments. Note that marine surveys may be conducted not only in saltwater environments, but also in fresh and brackish waters. Marine surveys come in at least two types. In a first, an array of streamers and sources is towed behind a survey vessel. This type of seismic survey is frequently referred to as a “towed-array” survey. In a second type, an array of seismic cables, each of which includes multiple sensors, is laid on the ocean floor, or sea bottom, and a source is towed from a survey vessel. This type of survey is sometimes called a “seabed survey.”

Although both are marine surveys, they present many very different technical challenges. Seabed surveys, for example, require a good coupling between the sensor housings and the sea bottom. This is not in any way a consideration for towed-array surveys since the acoustic sensors do not contact the sea bottom. Towed-array surveys are subject to noise generated by the movement of the streamers through the water. This is not a consideration for seabed surveys since the cables are stationary on the sea bottom during the survey. Thus, although both are marine surveys in the sense that they are conducted in water, they are very different in structure and operation.

Historically, towed-array seismic surveys have only employed pressure waves and the receivers detected any passing wavefront. This sometimes leads to difficulties in processing. The art has therefore recently begun moving to “multicomponent” surveys in which, for example, not only is the passing of a wavefront detected, but also the direction in which it is propagating. Multicomponent surveys include a plurality of receivers that enable the detection of pressure and particle velocity or time derivatives thereof (hereafter referred to as “particle motion sensors”). In so-called multi-sensor towed streamers, the streamer carries a combination of pressure sensors and particle motion sensors. The pressure sensor is typically a hydrophone, and the particle motion sensors are typically geophones or accelerometers. Knowledge of the direction of travel permits determination, for example, of which wavefronts are traveling upward and which are traveling downwards. The downward-traveling waves will yield undesirable information if confused with upwards traveling waves.

Conventional towed array seismic data is typically recorded with instrument low-cut filters switched in between 6 Hz and 8 Hz. That is, they use seismic survey signals with a low end frequency of about 6 Hz-8 Hz. Two immediate reasons for this are to filter out low-frequency, ocean swell noise and to reduce cable tow noise. A more fundamental reason, however, is that there is a marine source/receiver “ghost filter” endemic to the recording environment due to the presence of the acoustic free surface. The recorded data includes not only the seismic data from the primary (subsurface) reflection, but also “mirrored” data from the surface ghost reflection.

There are a number of reasons why it is desirable to record seismic frequencies below 6 Hz-8 Hz. Since the slope of the low frequency receiver ghost cutoff mechanism is proportional to depth of tow, it would seem natural to open up the low frequency end of the seismic band by towing the receivers deeper. Doing this, however, creates other problems. A deeper tow increases the delay time of the ghost echo. This, in turn, results in interference in the main seismic band.

The challenge posed by the ghost response is analogous to the difficulty faced by a human listener trying to understand speech over a voice channel corrupted with system echo. If the echo delay in the system is short relative to the speaker's resonant voice decay, there is no noticeable problem. As the echo time increases, however, it becomes a serious issue for the listener by generating interference in the main frequency band of the communication channel. Thus, the arrays are conventionally towed at a depth of approximately 4 m-6 m to mitigate the effects of the ghost reflection.

The present invention is directed to resolving, or at least reducing, one or all of the problems mentioned above.

### SUMMARY OF THE INVENTION

In a first aspect, the present invention includes a method, comprising: acquiring a set of multicomponent seismic data in a towed-array, marine seismic survey at a low seismic frequency and at a deep seismic depth; and processing the acquired seismic data to attenuate the affect of reverberations in the water column thereon.

In a second aspect, the present invention includes a method for processing seismic data, comprising: accessing a set of multicomponent seismic data acquired in a towed-array, marine seismic survey at a low seismic frequency and at a deep seismic depth; and processing the acquired seismic data to attenuate the affect of reverberations in the water column thereon. In other aspects, the invention includes a computing apparatus programmed to perform such a method and a programs storage medium encoded with instructions that, when executed by a computing apparatus, perform such a method.

In another aspect, the invention includes a method of acquiring multicomponent seismic data, comprising: towing a marine seismic array at a deep seismic depth; imparting a seismic survey signal into the marine environment, the seismic survey signal having a low seismic frequency; detecting a reflection of the seismic survey signal with the towed marine seismic array; and recording the detected reflection.

### BRIEF DESCRIPTION OF THE DRAWINGS

The invention may be understood by reference to the following description taken in conjunction with the accompanying drawings, in which like reference numerals identify like elements, and in which:

FIG. 1A and FIG. 1B depict a towed-array, marine seismic survey practiced in accordance with one aspect of the present invention;

FIG. 2 conceptually depicts a sensor arrangement for the marine seismic survey of FIG. 1A-FIG. 1B;

FIG. 3 shows selected portions of the hardware and software architecture of a computing apparatus such as may be employed in some aspects of the present invention;

FIG. 4 depicts a computing system on which some aspects of the present invention may be practiced in some embodiments;

FIG. 5 illustrates the determination of a scale factor for the embodiment disclosed herein;

FIG. 6 illustrates a method practiced in accordance with one aspect of the present invention to acquire multicomponent seismic data of FIG. 3 in the course of the survey of FIG. 1A-FIG. 1B;

FIG. 7 illustrates a method practiced in accordance with another aspect of the present invention to process the seismic data of FIG. 3 acquired as illustrated in FIG. 1A-FIG. 1B; and

FIG. 8 illustrates a method practiced in accordance with yet another aspect of the present invention to acquire multicomponent seismic data of FIG. 3 in the course of the survey of FIG. 1A-FIG. 1B and to process the seismic data of FIG. 3.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

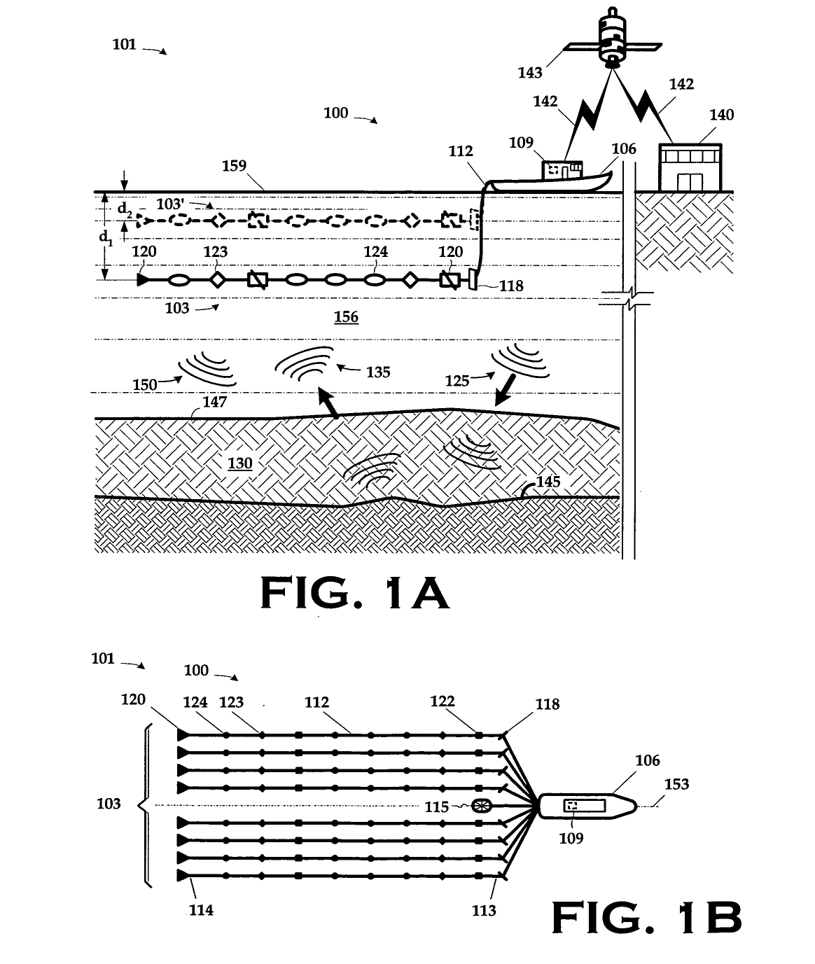

FIG. 1A and FIG. 1B illustrate a towed-array survey system 100 in a towed-array marine survey 101, both of which are exemplary embodiments of their respective aspects of the present invention. In this particular embodiment, the survey system 100 generally includes an array 103 towed by a survey vessel 106 on board of which is a computing apparatus 109. The towed array 103 comprises eight marine seismic cables 112 (only one indicated) that may, for instance, each be 6 km long. Note that the number of seismic cables 112 in the towed array 103 is not material to the practice of the invention. Thus, alternative embodiments may employ different numbers of seismic cables 112. In some embodiments, the outermost seismic cables 112 in the array 103 could be, for example, 700 meters apart.

A seismic source 115 is also shown being towed by the survey vessel 106 in FIG. 1B. Note that, in alternative embodiments, the seismic source 115 may not be towed by the survey vessel 106. Instead, the seismic source 115 may be towed by a second vessel (not shown), suspended from a buoy (also not shown), or deployed in some other fashion known to the art. The known seismic sources include impulse sources, such as explosives and air guns, and vibratory sources which emit waves with a more controllable amplitude and frequency spectrum. The seismic source 115 may be implemented using any such source known to the art. In the illustrated embodiment, the seismic source 115 comprises an air gun or an array of air guns

At the front of each seismic cable 112 is a deflector 118 (only one indicated) and at the rear of every seismic cable 112 is a tail buoy 120 (only one indicated). The deflector 118 laterally, or in the crossline direction, positions the front end 113 of the seismic cable 112 nearest the survey vessel 106. The tail buoy 120 creates drag at the tail end 114 of the seismic cable 112 farthest from the survey vessel 106. The tension created on the seismic cable 112 by the deflector 118 and the tail buoy 120 results in the roughly linear shape of the seismic cable 112 shown in FIG. 1A-FIG. 1B.

Located between the deflector 118 and the tail buoy 120 are a plurality of seismic cable positioning devices known as “birds” 122. The birds 122 may be located at regular intervals along the seismic cable, such as every 200 to 400 meters. In this particular embodiment, the birds 122 are used to control the depth at which the seismic cables 112 are towed, typically a few meters. In one particular embodiment, the steerable birds 118 are implemented with Q-fin™ steerable birds as are employed by Western Geco, the assignee hereof, in their seismic surveys.

The principles of design, operation, and use of such steerable birds are found in PCT International Application WO 00/20895, entitled “Control System for Positioning of Marine Seismic Streamers”, filed under the Patent Cooperation Treaty on Sep. 28, 1999, in the name of Services Petroliers Schlumberger as assignee of the inventors Øyvind Hillesund et al. (“the '895 application”). However, any type of steerable device may be employed. For instance, a second embodiment is disclosed in PCT International Application No. WO 98/28636, entitled “Control Devices for Controlling the Position of a Marine Seismic Streamer”, filed Dec. 19, 1997, in the name of Geco AS as assignee of the inventor Simon Bittleston (“the '636 application”). In some embodiments, the birds 118 may even be omitted.

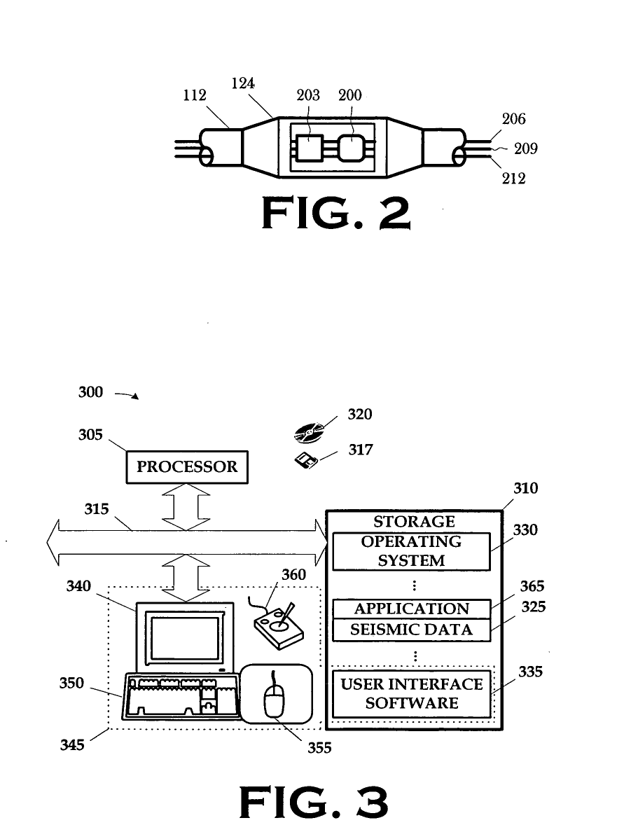

The seismic cables 112 also include a plurality of instrumented sondes 124 (only one indicated) distributed along their length. The instrumented sondes 124 house, in the illustrated embodiment, an acoustic sensor 200 (e.g., a hydrophone) such as is known to the art, and a particle motion sensor 203, both conceptually shown in FIG. 2. The particle motion sensors 203 measure not only the magnitude of passing wavefronts, but also their direction. The sensing elements of the particle motions sensors may be, for example, a velocity meter or an accelerometer. Suitable particle motion sensors are disclosed in:
U.S. application Ser. No. 10/792,511, entitled “Particle Motion Sensor for Marine Seismic Sensor Streamers,” filed Mar. 3, 2004, in the name of the inventors Stig Rune Lennart Tenghamn and Andre Stenzel (published Sep. 8, 2005, as Publication No. 2005/0194201);
U.S. application Ser. No. 10/233,266, entitled “Apparatus and Methods for Multicomponent Marine Geophysical Data Gathering,” filed Aug. 30, 2002, in the name of the inventors Stig Rune Lennart Tenghamn et al. (published Mar. 4, 2004, as Publication No. 2004/0042341); and
U.S. Pat. No. 3,283,293, entitled “Particle Velocity Detector and Means for Canceling the Effects of Motional Disturbances Applied Thereto,” naming G. M. Pavey, Jr. et al. as inventors, and issued Nov. 1, 1966.

### Any suitable particle motion sensor known to the art may be used to implement the particle motion sensor 203.

In general, it is desirable for the noise measurements of the particle motion sensors 203 be taken as close to the point the seismic data is acquired by the acoustic sensors 200 as is reasonably possible. More distance between the noise data acquisition and the seismic data acquisition will mean less accuracy in the measurement of noise at the point of seismic data acquisition. However, it is not necessary that the particle motion sensor 203 be positioned together with the acoustic sensor 200 within the sensor sonde 124. The particle motion sensor 203 need only be located sufficiently proximate to the acoustic sensor 200 that the noise data it acquires reasonably represents the noise component of the acquired seismic data.

The sensors of the instrumented sondes 124 then transmit data representative of the detected quantity over the electrical leads of the seismic cable 112. The data from the acoustic sensors 200 and the particle motion sensors 203 may be transmitted over separate lines. However, this is not necessary to the practice of the invention. However, size, weight and power constraints will typically make this desirable. The data generated by the particle motion sensor 203 will therefore need to be interleaved with the seismic data. Techniques for interleaving information with this are known to the art. For instance, the two kinds of data may be multiplexed. Any suitable techniques for interleaving data known to the art may be employed.

Thus, the data generated by the sensors of the instrumented sondes 124 is transmitted over the seismic cable to the computing apparatus 109. As those in the art will appreciate, a variety of signals are transmitted up and down the seismic cable 112 during the seismic survey. For instance, power is transmitted to the electronic components (e.g., the acoustic sensor 200 and particle motion sensor 203), control signals are sent to positioning elements (not shown), and data is transmitted back to the vessel 110. To this end, the seismic cable 112 provides a number of lines (i.e., a power lead 206, a command and control line 209, and a data line 212) over which these signals may be transmitted. Those in the art will further appreciate that there are a number of techniques that may be employed that may vary the number of lines used for this purpose. Furthermore, the seismic cable 112 will also typically include other structures, such as strengthening members (not shown), that are omitted for the sake of clarity.

Returning to FIG. 1A and FIG. 1B, the computing apparatus 109 receives the seismic data (hydrophone as well as particle motion sensor data), and records it. The particle motion sensor data is recorded in, for example, a data storage in any suitable data structure known to the art. The particle motion sensor data can then be processed along with the hydrophone data to for instance suppress unwanted multiples. The computing apparatus 109 interfaces with the navigation system (not shown) of the survey vessel 106. From the navigation system, the computing apparatus 109 obtains estimates of system wide parameters, such as the towing direction, towing velocity, and current direction and measured current velocity.

In the illustrated embodiment, the computing apparatus 109 monitors the actual positions of each of the birds 122 and is programmed with the desired positions of or the desired minimum separations between the seismic cables 112. The horizontal positions of the birds 122 can be derived using various techniques well known to the art. The vertical positions, or depths, of the birds 122 are typically monitored using pressure sensors (not shown) attached to the birds 122.

Although drag from the tail buoy 120 tends to keep the seismic cables 112 straight, and although the birds 122 can help control the position of the seismic cables 112, environmental factors such as wind and currents can alter their shape. This, in turn, affects the position of the instrumented sondes 124 and, hence, the sensors 200, 203 (shown in FIG. 2). The shape of the seismic cable 112 may be determined using any of a variety of techniques known to the art. For instance, satellite-based global positioning system equipment can be used to determine the positions of the equipment. The Global Positioning System (“GPS”), or differential GPS, are useful, with GPS receivers (not shown) at the front and tail of the streamer.

In addition to GPS based positioning, it is known to monitor the relative positions of streamers and sections of streamers through a network of sonic transceivers 123 (only one indicated) that transmit and receive acoustic or sonar signals. Alternatively, or in addition to GPS, commonly employed acoustic positioning techniques may be employed. The horizontal positions of the birds 122 and instrumented sondes 124 can be derived, for instance, using the types of acoustic positioning system described in:
(i) U.S. Pat. No. 4,992,990, entitled “Method for Determining the Position of Seismic Streamers in a Reflection Seismic Measuring System”, issued Feb. 12, 1991, to Geco A. S. as assignee of the inventors Langeland, et al. (the “'990 patent”);
(ii) U.S. application Ser. No. 10/531,143, entitled “Method and Apparatus for Positioning Seismic Sensing Cables”, filed Apr. 8, 2005, in the name of James L. Martin et al. (the “'143 application”); and
(iii) International Application Serial No. PCT/GB 03/04476 entitled “Method and Apparatus for Determination of an Acoustic Receiver's Position”, filed Oct. 13, 2003, in the name of James L. Martin et al. (the “'476 application”).

### However, any suitable technique known to the art for cable shape determination may be used.

The survey vessel 106 tows the array 103 across the survey area in a predetermined pattern. The predetermined pattern is basically comprised of a plurality of “sail lines” along which the survey vessel 106 will tow the array 103. Thus, at any given time during the survey, the survey vessel 106 will be towing the array 103 along a predetermined sail line 153.

Note that, as is shown in FIG. 1A, the towed array 103 is towed at a deep seismic depth d₁ that is deeper than conventional depths d₂. A towed array 103′ is shown in broken lines at the conventional depth d₂ to provide a comparison and illustrate the difference. Conventional depths are approximately 4 m-6 m, whereas the deep seismic depths of the present invention are approximately 20 m-25 m, although alternative embodiments may operate at depths of approximately 6 m-20 m, i.e., deeper than conventional depths. In conventional practice, these depths would lead to the kinds of problems discussed above. However, the present invention permits acquisition at these deep seismic depths with acceptable performance as will be discussed further below.

Still referring to FIG. 1A-FIG. 1B, the seismic source 115 generates a plurality of seismic survey signals 125 as the survey vessel 106 tows the array 103. The signals 125 are generated in accordance with conventional practice, but their characteristics differ from those seismic survey signals used in conventional practice. More particularly, the signals 125 are low seismic frequency signals. As noted above, conventional seismic survey signals are typically approximately 6 Hz-8 Hz. In the present invention, the low seismic frequency signals 125 are approximately 3 Hz-60 Hz.

The seismic survey signals 125 propagate and are reflected by the subterranean geological formation 130. The geological formation 130 presents a seismic reflector 145. As those in the art having the benefit of this disclosure will appreciate, geological formations under survey can be much more complex. For instance, multiple reflectors presenting multiple dipping events may be present. FIG. 1A-FIG. 1B omit these additional layers of complexity for the sake of clarity and so as not to obscure the present invention. The sensors 200, 203 detect the reflected signals 135 from the geological formation 130 in a conventional manner.

The sensors 200, 203 (shown in FIG. 2) in the instrumented sondes 124 then generate data representative of the reflections 135, and the seismic data is embedded in electromagnetic signals. Note that the generated data is multicomponent seismic data. The signals generated by the sensors 200, 203 are communicated to the computing apparatus 109. The computing apparatus 109 collects the seismic data for processing.

The computing apparatus 109 is centrally located on the survey vessel 110. However, as will be appreciated by those skilled in the art, various portions of the computing apparatus 109 may be distributed in whole or in part, e.g., across the seismic recording array 105, in alternative embodiments.

The computing apparatus 109 may process the seismic data itself, store the seismic data for processing at a later time, transmit the seismic data to a remote location for processing, or some combination of these things. Typically, processing occurs on board the survey vessel 106 or at some later time rather than in the survey vessel 106 because of a desire to maintain production. The data may therefore be stored on a portable magnetic storage medium (not shown) or wirelessly transmitted from the survey vessel 106 to a processing center 140 for processing in accordance with the present invention. Typically, in a marine survey, this will be over satellite links 142 and a satellite 143. Note that some alternative embodiments may employ multiple data collection systems 120.

The multicomponent seismic data acquired as described above is then processed. FIG. 3 shows selected portions of the hardware and software architecture of a computing apparatus 300 such as may be employed in some aspects of the present invention. Note that, in some embodiments, the computing apparatus 300 may be an implementation of computing apparatus 109, shown in FIG. 1A-FIG. 1B, on board the survey vessel 106. However, in the illustrated embodiment, the computing apparatus is a separate computing apparatus located at the processing center 140, shown in FIG. 1A-FIG. 1B.

The computing apparatus 300 includes a processor 305 communicating with storage 310 over a bus system 315. The storage 310 may include a hard disk and/or random access memory (“RAM”) and/or removable storage such as a floppy magnetic disk 317 and an optical disk 320. The storage 310 is encoded with a seismic data 325. The seismic data 325 is acquired as discussed above relative to FIG. 1A-FIG. 1B. The seismic data 325 is multicomponent data and, in this particular embodiment, includes data from both of the sensors 200, 203.

The storage 310 is also encoded with an operating system 330, user interface software 335, and an application 365. The user interface software 335, in conjunction with a display 340, implements a user interface 345. The user interface 345 may include peripheral I/O devices such as a keypad or keyboard 350, a mouse 355, or a joystick 360. The processor 305 runs under the control of the operating system 330, which may be practically any operating system known to the art. The application 365 is invoked by the operating system 330 upon power up, reset, or both, depending on the implementation of the operating system 330. The application 365, when invoked, performs the method of the present invention. The user may invoke the application in conventional fashion through the user interface 345.

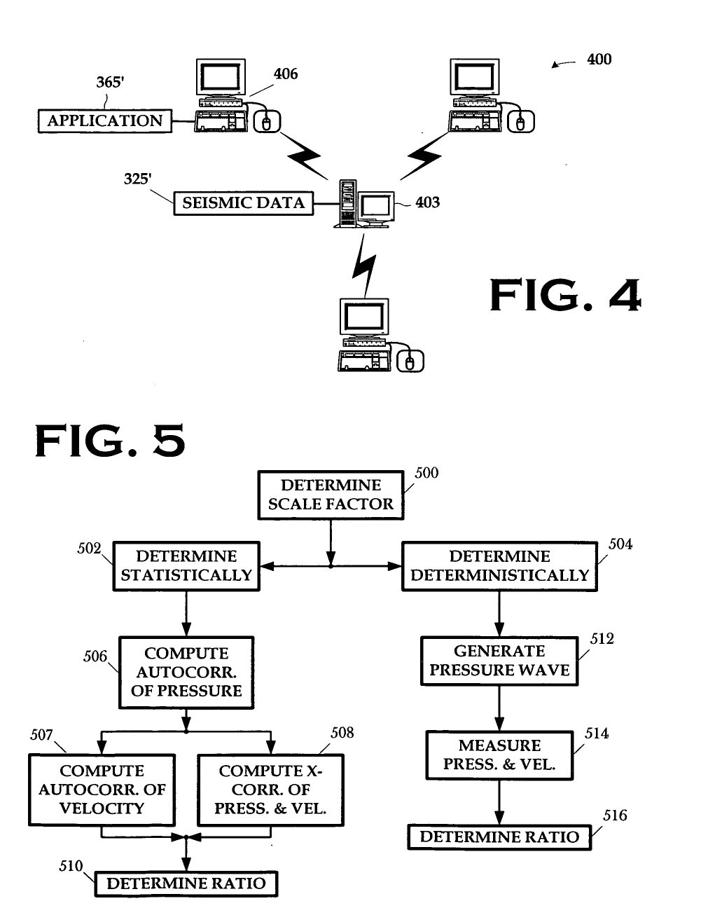

Note that there is no need for the seismic data 325 to reside on the same computing apparatus 300 as the application 365 by which it is processed. Some embodiments of the present invention may therefore be implemented on a computing system, e.g., the computing system 400 in FIG. 4, comprising more than one computing apparatus. For example, the seismic data 325 may reside in a data structure residing on a server 403 and the application 365′ by which it is processed on a workstation 406 where the computing system 400 employs a networked client/server architecture.

However, there is no requirement that the computing system 400 be networked. Alternative embodiments may employ, for instance, a peer-to-peer architecture or some hybrid of a peer-to-peer and client/server architecture. The size and geographic scope of the computing system 400 is not material to the practice of the invention. The size and scope may range anywhere from just a few machines of a Local Area Network (“LAN”) located in the same room to many hundreds or thousands of machines globally distributed in an enterprise computing system.

Returning now to FIG. 3 and referring to FIG. 1A, the application 365 operates on the seismic data 325 to attenuate the affect of reverberations, such as the ghost reflection 150, in the water column 156. As described above, the seismic data 325 is multicomponent data acquired during a deep tow, low frequency towed-array survey. In particular, in the illustrated embodiment, the application performs the method of U.S. Pat. No. 4,979,150, entitled “System for Attenuation of Water-Column Reverberations”, issued Dec. 18, 1990, to Halliburton Geophysical Services, Inc., as assignee of the inventor Frederick J. Barr (“the 150 patent”).

The '150 patent discloses a technique for use in mitigating the effect of reverberations, such as a ghost reflection, on seismic data collected in the course of a seabed survey, i.e., seabed seismic data. In one particular embodiment, pressure and particle motion data is collected in a streamer, i.e., streamer calibration data. The streamer calibration data is then used to process the seabed seismic data to attenuate the effect of the reverberations. In accordance with the present invention, this particular embodiment can be adapted to a towed-array survey acquiring multicomponent data to directly mitigate the effect of the ghost reflection therein.

Accordingly, those portions of the '150 patent disclosing the embodiment wherein streamer calibration data is used to correct the seabed seismic data is hereby incorporated by reference for all purposes as if set forth verbatim herein. However, that embodiment is modified in accordance with the present invention for use with streamer seismic data such as the seismic data 325, shown in FIG. 3. Therefore, to further an understanding of the present invention, selected portions of the '150 patent are reproduced herein modified as for use in accordance with the present invention.

In general, this particular technique reduces coherent noise by applying a scale factor to the output of a pressure transducer and a particle velocity transducer—i.e., the acoustic sensor 200 and particle motion sensor 203, respectively, both shown in FIG. 2—positioned substantially adjacent one another in the water. The sensors are positioned at a point in the water above the bottom—i.e., at the deep seismic depth—and, thereby, eliminate downgoing components of reverberation. The scale factor, which derives from the acoustical impedance of the water, can be determined both deterministically and statistically. The former involves measuring and comparing the responses of the pressure and velocity sensors to a pressure wave—i.e., the signals 125—induced in the water. The latter involves comparing the magnitude of the pressure signal autocorrelation to the pressure and velocity signal crosscorrelation at selected lag values or, alternatively, comparing the magnitude of the pressure signal autocorrelation to the velocity signal autocorrelation at selected lag values.

A scale factor for use in conjunction with a hydrophone/geophone pair positioned at a point in the water above the bottom—i.e., the acoustic sensor 200 and particle motion sensor 203, respectively, both shown in FIG. 2—is:

$$( \frac{{ρ}^{′} {α}^{′}}{{Dir}_{corr}} ) * ( \frac{{G}_{p}}{{G}_{v}} )$$

where:
ρ′≡a density of the water;
α′≡a velocity of propagation of the seismic wave in the water;
Gₚ≡a transduction constant associated with the water pressure detecting step (e.g., a transduction constant of the transducer with which the water pressure is recorded);
Gᵥ≡a transduction constant associated with the water velocity detecting step (e.g., a transduction constant of the transducer with which the particle velocity is detected); and
Dir_{corr}≡a directivity correction factor associated with an angle of propagation of the seismic wave in the water.

The directivity correction factor, Dir_{corr}, is expressed as a function of γₚ′, the angle of propagation from vertical of the seismic wave in the water. Here, Dir_{corr} is equal to cos(γₚ′) for γₚ′ less than a selected critical angle and, otherwise, is equal to 1. The critical angle is a function of the propagation velocity of the seismic wave and can be substantially equal to arcsin

$$\frac{{α}^{′}}{( α )} ,$$

where (α′) is the velocity of propagation of the seismic wave in the water and (α) is a velocity of propagation of the seismic wave in an earth material at said water's bottom.

One sequence for computing the scale factor will now be described in conjunction with FIG. 5_{[JP1]}. FIG. 5 depicts a processing sequence (at 500) for determining the scale factor either deterministically (at 502), or statistically (at 504), or both ways. While the deterministic method, which requires the sounding and measurement of transducer responsiveness, is preferred, the statistical method based on ratios of the pressure and particle velocity autocorrelations and crosscorrelations can also be used. Those skilled in the art will appreciate, of course, that both methods can be used in combination.

The statistical determination (at 502) computes the autocorrelation of the pressure at a selected lag (at 506). The autocorrelation of the velocity at a selected lag is also computed (at 507). Alternatively, the crosscorrelation of the pressure and particle velocity at a selected lag to wit, the two-way travel time of the seismic wave in the water column 156, shown in FIG. 1A, may be computed (at 508). Preferably, the lags for the computations (at 506, 507) are zero. However, the lags for this combination can also be equal to the two-way travel time of the seismic wave between the sonde 124 and the water surface 159. The statistical determination (at 502) then divides (at 510) the pressure autocorrelation by the velocity autocorrelation or, alternatively, the system divides the pressure autocorrelation by the pressure-velocity crosscorrelation.

In the discussion which follows, it is assumed that the velocity signal has been multiplied by the factor:

$$( \frac{{G}_{p}}{{G}_{v}} ) ( {ρ}^{′} {α}^{′} )$$

Mathematically, the autocorrelation/crosscorrelation ratio is expressed as follows:

$${Φ}_{pp} ( \pm \frac{2 d}{{α}^{′}} ) = {T}^{2} \{ - ( 1 + R ) - {R ( 1 + R )}^{2} - {{R}^{3} ( 1 + R )}^{2} - … \}$$

$${Φ}_{pv} ( \frac{2 d}{{α}^{′}} ) = {T}^{2} \{ ( 1 - R ) + R ( 1 - {R}^{2} ) + {R}^{3} ( 1 - {R}^{2} ) + … \}$$

$$Therefore$$

$$\frac{{Φ}_{pp} ( \pm \frac{2 d}{{α}^{′}} )}{{Φ}_{pv} ( \frac{2 d}{{α}^{′}} )} = \frac{( 1 + R ) + {R ( 1 + R )}^{2} + {{R}^{3} ( 1 + R )}^{2} + …}{( 1 - R ) + R ( 1 - {R}^{2} ) + {R}^{3} ( 1 - {R}^{2} ) + …} = \frac{1 + R}{1 - R}$$

which is equal to the required scale factor for v(t).

Mathematically, the ratio of the pressure and velocity autocorrelations at zero lag is expressed as follows:

Φₚₚ(0)=T²{1+(1+R)²+R²(1+R)²+R⁴(1+R)²+ . . . }

Φᵥᵥ(0)=T²{1+(1−R)²+R²(1−R)²+R⁴(1−R)²+ . . . }

Forming the ratio of these two values yields:

$$\begin{matrix}\frac{{Φ}_{pp} ( 0 )}{{Φ}_{vv} ( 0 )} = \frac{1 + {( 1 + R )}^{2} + {R}^{2} ( 1 + {R}^{2} ) + {{R}^{4} ( 1 + R )}^{2} + …}{1 + {( 1 - R )}^{2} + {{R}^{2} ( 1 - R )}^{2} + {{R}^{4} ( 1 - R )}^{2} + …} \\ = \frac{1 + R + {R}^{2} + {R}^{3} + {R}^{4} + {R}^{5} + {R}^{6} …}{1 - R + {R}^{2} - {R}^{3} + {R}^{4} - {R}^{5} + {R}^{6} …}\end{matrix}$$

$$\frac{{Φ}_{pp} ( 0 )}{{Φ}_{vv} ( 0 )} = \frac{1 + R}{1 - R}$$

Accordingly, K is obtained as follows:

$$K = ( \frac{{Φ}_{pp} ( 0 )}{{Φ}_{vv} ( 0 )} )$$

Further, the ratio of the pressure wave autocorrelation to the velocity wave autocorrelation at a lag equal to the two-way travel time of the seismic wave in the water column may be expressed mathematically as follows:

$${Φ}_{pp} ( \frac{\pm 2 d}{{α}^{′}} ) = {T}^{2} \{ - ( 1 + R ) - {R ( 1 + R )}^{2} - {{R}^{3} ( 1 + R )}^{2} - … \}$$

$${Φ}_{vv} ( \frac{\pm 2 d}{{α}^{′}} ) = {T}^{2} \{ ( 1 - R ) - {R ( 1 - R )}^{2} - {{R}^{3} ( 1 - R )}^{2} - … \}$$

Forming the following ratio:

$$\begin{matrix}\frac{- {Φ}_{pp} ( \frac{\pm 2 d}{{α}^{′}} )}{{Φ}_{vv} ( \frac{\pm 2 d}{{α}^{′}} )} = \frac{( 1 + R ) + {R ( 1 + R )}^{2} + {{R}^{3} ( 1 + R )}^{2} + …}{( 1 - R ) - {R ( 1 - R )}^{2} - {{R}^{3} ( 1 - R )}^{2} - …} \\ = \frac{1 + 2 R + 2 {R}^{2} + 2 {R}^{3} + 2 {R}^{4} + …}{1 - 2 R + 2 {R}^{2} - 2 {R}^{3} + 2 {R}^{4} - …}\end{matrix}$$

$$\frac{- {Φ}_{pp} ( \frac{\pm 2 d}{{α}^{′}} )}{{Φ}_{vv} ( \frac{\pm 2 d}{{α}^{′}} )} = {[ \frac{1 + R}{1 - R} ]}^{2}$$

$$Therefore$$

$$K = {[ \frac{- {Φ}_{pp} ( \frac{\pm 2 d}{{α}^{′}} )}{{Φ}_{vv} ( \frac{\pm 2 d}{{α}^{′}} )} ]}^{\frac{1}{2}}$$

Returning to FIG. 5, according to the deterministic approach (at 504), a seismic energy source 115 generates a pressure wave—the seismic signal 125—at a point disposed directly above the location of the sonde 124 in the water (at 512). The output of the pressure and particle velocity sensors 200, 203 are then measured (at 514) at a selected arrival of the resulting pressure wave—i.e., the reflection 135. A ratio of this measured pressure signal to the particle velocity signal is then used as the aforementioned scale factor (at 516).

Thus, in summary, the application 365, shown in FIG. 3, removes downwardly propagating components of the reverberations found in the seismic data 325 by multiplying the velocity function by

$$( \frac{{ρ}^{′} {α}^{′}}{{Dir}_{corr}} ) * ( \frac{{G}_{p}}{{G}_{v}} )$$

where:
ρ′≡a density of the water;
α′≡a velocity of propagation of the seismic wave in the water;
Gₚ≡a transduction constant associated with the water pressure detecting step (e.g., a transduction constant of the transducer with which the water pressure is recorded);
Gᵥ≡a transduction constant associated with the water velocity detecting step (e.g., a transduction constant of the transducer with which the particle velocity is detected); and
Dir_{corr}≡a directivity correction factor associated with an angle of propagation of the seismic wave in the water.

The scale factor can be determined statistically or deterministically. The former involves determining the ratio of a selected lag of the autocorrelation of the water pressure to a selected lag of crosscorrelation of the water pressure and water velocity at selected lag values. Preferably, however, the statistical determination involves computing the ratio of the autocorrelation of the water pressure at selected lag to the autocorrelation of the water velocity at a selected lag. The selected lags can correspond, for example, to a time of two-way travel of seismic wave through said water between the position at which the pressure and velocity detectors reside and the water's surface 159. Preferably, however, the selected lags are zero.

Derivation of the scale factor deterministically involves generating a pressure wave from a position above the sensor point (i.e., the point at which the pressure and particle velocity readings are taken during seismic data collection). The scale factor can then be derived from the ratio of the absolute values of the pressure and particle velocity magnitudes at the sensor point during selected arrivals, e.g., the first, of that pressure wave.

Further, whereas the above-described scale factor is preferably multiplied by the measured particle velocity function, those skilled in the art will appreciate that the measured pressure function could, instead, be multiplied by a factor directly related to that scale factor and the particle velocity function could be multiplied by one. It will further be appreciated that both signals could be multiplied by factors directly related to the scale factor.

As is apparent from the discussion above, some portions of the detailed descriptions herein are presented in terms of a software implemented process involving symbolic representations of operations on data bits within a memory in a computing system or a computing device. These descriptions and representations are the means used by those in the art to most effectively convey the substance of their work to others skilled in the art. The process and operation require physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

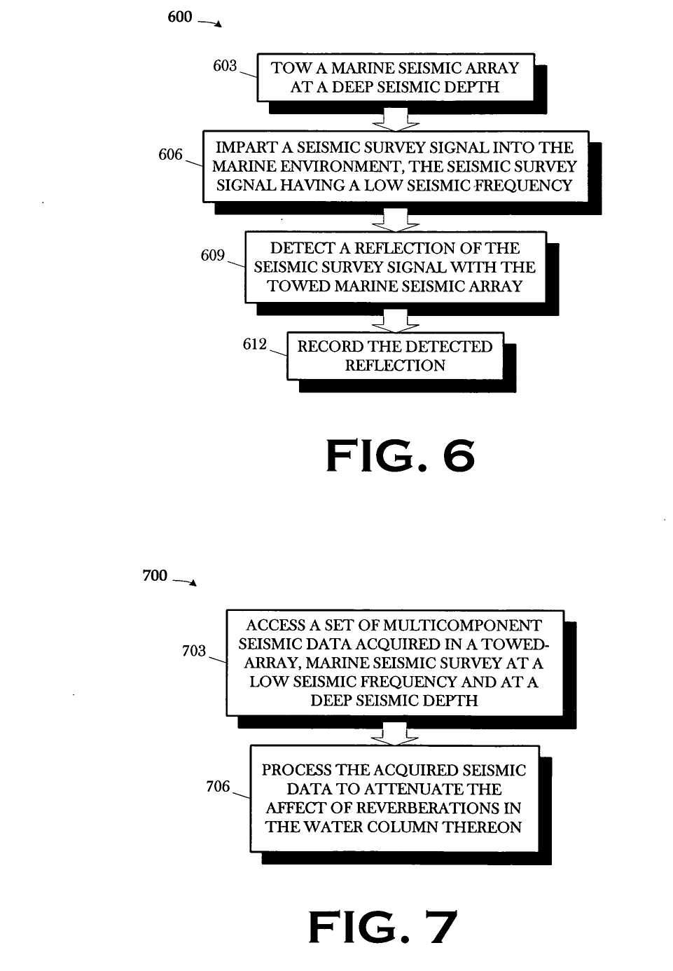

Returning to FIG. 1A-FIG. 1B and referring to FIG. 6, in a first aspect, the invention includes a method 600, shown in FIG. 6, of acquiring multicomponent seismic data. The method 600 comprises:
towing (at 603) a marine seismic array (e.g., the array 103) at a deep seismic depth (e.g., the depth d₁);
imparting (at 606) a seismic survey signal (e.g., the signal 125) into the marine environment, the seismic survey signal having a low seismic frequency;
detecting (at 609) a reflection (e.g., the reflection 135) of the seismic survey signal with the towed marine seismic array; and
recording (at 612) the detected reflection.
   Note that, as used herein, a “deep seismic depth” is a depth exceeding conventional practice for towed-array marine surveys (e.g., exceeding approximately 4 m-6 m) and a “low seismic frequency” is a frequency lower than that conventionally employed in towed-array seismic surveys (e.g., lower than approximately 6 Hz-8 Hz).

Referring now to FIG. 3 and FIG. 7, in another aspect, the present invention includes a method 700 for processing seismic data, comprising:
accessing (at 703) a set of multicomponent seismic data (e.g., the seismic data 325) acquired in a towed-array, marine seismic survey (e.g., the survey 100, in FIG. 1A-FIG. 1B) at a low seismic frequency and at a deep seismic depth; and
processing (at 706) the acquired seismic data to attenuate the affect of reverberations (e.g., the ghost signal 150, in FIG. 1A) in the water column (e.g., the water column 156, in FIG. 1A) thereon.
   In other aspects, the invention includes a computing apparatus (e.g., the computing apparatus 300) programmed to perform such a method and a programs storage medium (e.g., the magnetic or optical disks 317, 320) encoded with instructions that, when executed by a computing apparatus, perform such a method.

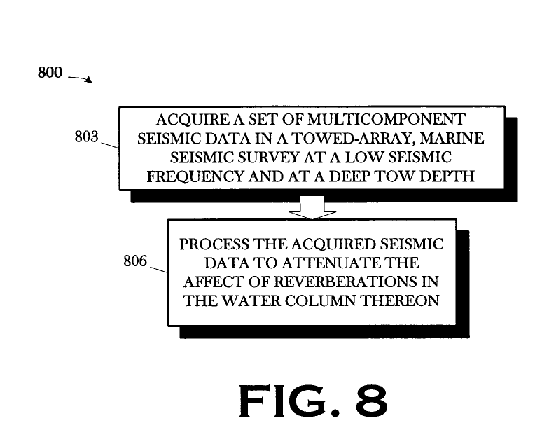

Referring now to FIG. 1A-FIG. 1B, FIG. 3, and FIG. 8, in another aspect, the present invention includes a method 800, comprising:
acquiring (at 803) a set of multicomponent seismic data (e.g., the seismic data 325) in a towed-array, marine seismic survey (e.g., the seismic survey 100) at a low seismic frequency and at a deep seismic depth; and
processing (at 806) the acquired seismic data to attenuate the affect of reverberations (e.g., the ghost reflection 150) in the water column thereon.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
acquiring a set of multicomponent seismic data in a towed-array, marine seismic survey at a low seismic frequency and at a deep tow depth; and
processing the acquired seismic data to attenuate the affect of reverberations in the water column thereon.

2. The method of claim 1, wherein acquiring the seismic data set includes acquiring a set of multicomponent seismic data at a seismic frequency of approximately 3 Hz-60 Hz and at a seismic depth of approximately 20 m-25 m.

3. The method of claim 1, wherein processing the acquired seismic data includes:
determining a scale factor; and
applying a scale factor to at least one of the pressure data and the particle motion data.

4. The method of claim 3, wherein the scale factor is determined from the acoustic impedance of the surrounding water.

5. The method of claim 3, wherein determining the scale factor includes statistically determining the scale factor.

6. The method of claim 5, wherein statistically determining the scale factor includes:
comparing the magnitude of the pressure signal autocorrelation to the pressure and velocity signal crosscorrelation at selected lag values; or
comparing the magnitude of the pressure signal autocorrelation to the velocity signal autocorrelation at selected lag values.

7. The method of claim 3, wherein determining the scale factor includes deterministically determining the scale factor.

8. The method of claim 4, wherein deterministically determining the scale factor includes comparing the responses of the pressure and velocity sensors to a seismic survey signal.

9. An apparatus, comprising:
acquiring a set of multicomponent seismic data in a towed-array, marine seismic survey at a low seismic frequency and at a deep tow depth; and
processing the acquired seismic data to attenuate the affect of reverberations in the water column thereon.

10. The apparatus of claim 9, wherein acquiring the seismic data set includes acquiring a set of multicomponent seismic data at a seismic frequency of approximately 3 Hz-60 Hz and at a seismic depth of approximately 20 m-25 m.

11. The apparatus of claim 9, wherein processing the acquired seismic data includes:
determining a scale factor; and
applying a scale factor to at least one of the pressure data and the particle motion data.

12. The apparatus of claim 11, wherein the scale factor is determined from the acoustic impedance of the surrounding water.

13. The apparatus of claim 11, wherein determining the scale factor includes statistically determining the scale factor.

14. The apparatus of claim 11, wherein determining the scale factor includes deterministically determining the scale factor.

15. A method for processing seismic data, comprising:
accessing a set of multicomponent seismic data acquired in a towed-array, marine seismic survey at a low seismic frequency and at a deep seismic depth; and
processing the acquired seismic data to attenuate the affect of reverberations in the water column thereon.

16. The method of claim 15, wherein acquiring the seismic data set includes acquiring a set of multicomponent seismic data at a seismic frequency of approximately 3 Hz-60 Hz and at a seismic depth of approximately 20 m-25 m.

17. The method of claim 15, wherein processing the acquired seismic data includes:
determining a scale factor; and
applying a scale factor to at least one of the pressure data and the particle motion data.

18. The method of claim 17, wherein the scale factor is determined from the acoustic impedance of the surrounding water.

19. The method of claim 17, wherein determining the scale factor includes statistically determining the scale factor.

20. The method of claim 19, wherein statistically determining the scale factor includes:
comparing the magnitude of the pressure signal autocorrelation to the pressure and velocity signal crosscorrelation at selected lag values; or
comparing the magnitude of the pressure signal autocorrelation to the velocity signal autocorrelation at selected lag values.

21. The method of claim 17, wherein determining the scale factor includes deterministically determining the scale factor.

22. The method of claim 19, wherein deterministically determining the scale factor includes comparing the responses of the pressure and velocity sensors to a seismic survey signal.

23. A computing apparatus, comprising:
a processor;
a bus system;
a storage communicating with the processor over the bus system; and
an application residing on the storage that, when invoked by the processor, performs a method for processing seismic data, the method comprising:
accessing a set of multicomponent seismic data acquired in a towed-array, marine seismic survey at a low seismic frequency and at a deep seismic depth; and
processing the acquired seismic data to attenuate the affect of reverberations in the water column thereon.

24. The computing apparatus of claim 23, wherein the seismic data set was acquired at a seismic frequency of approximately 3 Hz-60 Hz and at a seismic depth of approximately 20 m-25 m.

25. The computing apparatus of claim 23, wherein processing the acquired seismic data in the method performed by the application includes:
determining a scale factor; and
applying a scale factor to at least one of the pressure data and the particle motion data.

26. The computing apparatus of claim 25, wherein the scale factor is determined from the acoustic impedance of the surrounding water.

27. The computing apparatus of claim 25, wherein determining the scale factor in the method performed by the application includes statistically determining the scale factor.

28. The computing apparatus of claim 25, wherein determining the scale factor in the method performed by the application includes deterministically determining the scale factor.

29. The computing apparatus of claim 23, further comprising the acquired data set residing on the storage.

30. A program storage medium encoded with instructions that, when executed by a computing device, performs a method for processing seismic data, the method comprising:
accessing a set of multicomponent seismic data acquired in a towed-array, marine seismic survey at a low seismic frequency and at a deep seismic depth; and
processing the acquired seismic data to attenuate the affect of reverberations in the water column thereon.

31. The program storage medium of claim 30, wherein acquiring the seismic data set in the method includes acquiring a set of multicomponent seismic data at a seismic frequency of approximately 3 Hz-60 Hz and at a seismic depth of approximately 20 m-25 m.

32. The program storage medium of claim 30, wherein processing the acquired seismic data in the method includes:
determining a scale factor; and
applying a scale factor to at least one of the pressure data and the particle motion data.

33. The program storage medium of claim 32, wherein the scale factor is determined from the acoustic impedance of the surrounding water.

34. The program storage medium of claim 32, wherein determining the scale factor in the method includes statistically determining the scale factor.

35. The program storage medium of claim 32, wherein determining the scale factor in the method includes deterministically determining the scale factor.

36. A method of acquiring multicomponent seismic data, comprising:
towing a marine seismic array at a deep seismic depth;
imparting a seismic survey signal into the marine environment, the seismic survey signal having a low seismic frequency;
detecting a reflection of the seismic survey signal with the towed marine seismic array; and
recording the detected reflection.

37. The method of claim 36, wherein acquiring the low seismic frequency approximately 3 Hz-80 Hz and the deep seismic depth is approximately 20 m-25 m.
